(19) United States
(12) Patent Application Publication
(10) Pub. No.: US 2023/0294096 A1
(43) Pub. Date: Sep. 21, 2023

(54) Microfluidic Treatment Apparatus and Method for Operating a Microfluidic Treatment Apparatus

(71) Applicant: Robert Bosch GmbH, Stuttgart (DE)

(72) Inventor: Daniel Sebastian Podbiel, Rutesheim (DE)

(21) Appl. No.: 18/041,761

(22) PCT Filed: Jul. 28, 2021
(86) PCT No.: PCT/EP2021/071095

§ 371 Date: Feb. 15, 2023

(30) Foreign Application Priority Data
Aug. 17, 2020 (DE) 10 2020 210 416.6

(51) Int. Cl. B01L 3/00; B01L 7/00

(52) U.S. Cl. CPC B01L 3/502753; B01L 3/502738; B01L 7/525; B01L 2300/0681; B01L 2400/0487

(57) ABSTRACT

A microfluidic treatment apparatus has a microfluidic channel system having a filtering branch, a pumping branch connected in parallel with the filtering branch, and a filter chamber arranged in the filtering branch and configured to accommodate a filter element. The filtering branch is coupled to a channel inlet via a first channel-crossover element and to a channel outlet via a second channel-crossover element, and the filter chamber can be isolated from the rest of the channel system by at least two filter valves. A pumping device is arranged in the pumping branch, is configured to produce fluid flow in the channel system, and includes at least one pumping valve and at least one pumping chamber. The pumping branch is coupled to the channel inlet via a connection of the first channel-crossover element and to the channel outlet via a connection of the second channel-crossover element

### PRIOR ART

The invention proceeds from a microfluidic treatment apparatus for treating a sample liquid and a method for operating a microfluidic treatment apparatus according to the genre of the independent claims. The subject-matter of the present invention is also a computer program.

Microfluidic analysis systems, called lab-on-chips or LoCs, permit an automated, reliable, fast, compact, and cost-effective treatment of patient samples for medical diagnostics. By combining a variety of operations for controlled manipulation of fluids, complex molecular diagnostic test procedures can be carried out on a lab-on-chip cartridge. An important operation here is the extraction of constituents, for example nucleic acids, from a sample, in particular from a sample liquid.

### DISCLOSURE OF THE INVENTION

In light of this background, with the approach presented herein, an improved microfluidic treatment apparatus for treating a sample liquid and an improved method for operating a microfluidic treatment apparatus, and furthermore a control unit using this method, and finally a corresponding computer program are presented according to the main claims. With the measures stated in the dependent claims, advantageous further developments and improvements of the apparatus specified in the independent claim are possible.

Advantageously, the approach presented herein as well as the use of the treatment apparatus presented herein enables a particularly high yield, i.e. a high extraction efficiency in the purification of a sample liquid. The presented treatment apparatus allows a particularly space-saving arrangement of the microfluidic channels as well as the necessary connections and interfaces to a microfluidic network, so that a particularly compact realization of a lab-on-chip cartridge is achieved. In particular, particularly inexpensive and resource-conserving production can be achieved, for example by reducing the use of material.

A microfluidic treatment apparatus for treating a sample liquid is presented, wherein the microfluidic treatment apparatus has at least one microfluidic channel system having at least one filtering branch and a pumping branch, which is connected in parallel with the filtering branch. In addition, the treatment apparatus has at least one filter chamber, which is arranged in the filtering branch and is intended for accommodating a filter element, wherein the filtering branch is, or can be, coupled fluidically to a channel inlet via a first channel-crossover element having and to a channel outlet via a second channel-crossover element, and wherein the filter chamber can be isolated fluidically from the rest of the channel system by way of at least two filter valves. In addition, the treatment apparatus has a pumping device, which is arranged in the pumping branch and is intended for producing a fluidic flow in the channel system, wherein the pumping device preferably comprises one pumping valve and at least one pumping chamber, and wherein the pumping branch is, or can be, coupled fluidically to the channel inlet via a connection of the first channel-crossover element which is different from that for the filtering branch and to the channel outlet via a connection of the second channel-crossover element which is different from that for the filtering branch. The first channel-crossover element and/or the second channel-crossover element can be T-shaped in a preferred configuration. In other words, the channel-crossover elements can each fluidically connect three channels in a common point. Alternatively, for example, a cross-shaped configuration of the first and/or the second channel-crossover element is also possible, i.e. a liquid connection of four channels in a point or, viewed differently, two channels that cross one another in a point and are fluidically connected in that point.

The microfluidic treatment apparatus has the advantage that, on the one hand, the filtering branch can be flushed upon opening of the filter valves or used for an extraction of constituents from a sample, in particular via the channel inlet and the channel outlet, and, on the other hand, the pumping branch can also be flushed, in particular when the filter valves are closed, in particular also via the channel inlet and the channel outlet. Moreover, a common flushing can advantageously be carried out through the filtering branch and the parallel pumping branch, preferably using the pumping device arranged in the pumping branch. Of particular advantage, it is also possible to carry out the common flushing as a circular flushing through the filtering branch and the pumping branch via the channel-crossover elements. In this manner, for example, an extraction, that is to say an enrichment on the filter element of constituents of the sample that are present in a sample, or an elution, that is to say a debonding of sample constituents previously enriched on the filter element, can occur.

The microfluidic treatment apparatus can thus advantageously be used for a flushing, in particular a purification, of the filter element, a sample purification or extraction of constituents from a sample on the filter element, or an elution, i.e. a debonding of sample constituents from the filter element, in particular a purification and elution of nucleic acids on or from the filter element. The flushing can be carried out in particular with a binding buffer, a wash buffer, or an elution buffer for the purification of a sample. The presented approach thus also comprises a method for operating the microfluidic treatment apparatus. Preferably, the flushing, in particular for a purification or washing of the filter element as described above, can be carried out via the channel inlet, filter element, and channel outlet, i.e. advantageously via a short path with a low potential dead volume. In this case, preferably no flushing liquid or, in particular in the case of a subsequent elution, as little flushing liquid as possible enters the pumping branch, which can be supported by the use of one or more pumping valves in the pumping branch or on the channel-crossover elements for separation of the pumping branch, wherein, for example, the pumping branch has only a small volume compared to the pumping branch. The purification of the sample on the filter element, that is to say in particular an extraction of constituents from the sample on the filter element, can preferably also be carried out via the channel inlet, filter element, and channel outlet, wherein preferably also no flushing liquid or as little flushing liquid as possible enters the pumping branch. Alternatively, the sample can be flushed via a circular flushing one or more times via the pumping branch through the filtering branch via the filter element, which supports an efficient purification. Then, as already stated, the filter element can be flushed with a wash buffer. The elution of sample constituents, in particular nucleic acids, from the filter element can preferably be carried out using the pumping branch, preferably using the pumping device. This is particularly advantageous when a further treatment or analysis of the sample constituents isolated by the filter element is to be carried out in the pumping branch, for example a duplication of nucleic acids via a polymerase chain reaction or isothermal amplification, in particular in one or more of the preferably temperature-controlled pumping devices or pumping chambers in the pumping branch.

For example, the treatment apparatus can have lateral dimensions of 30 × 30 mm² to 300 × 300 mm², preferably 50 × 50 mm² to 100 × 100 mm². For example, the treatment apparatus can be a polymeric cartridge with active or activatable microfluidic elements, that is to say microfluidic valves and pumping chambers, which can cause a respective displacement of liquids from a designated portion of liquid-bearing structures of the treatment apparatus. For example, the valves and pumping chambers can be pneumatically actuated by a dedicated processing unit, so that a fully automated microfluidic processing of the liquids in the polymeric cartridge can be achieved. The valves and pumping chambers can be realized or covered by at least one flexible membrane, which can be adj acent to further polymeric components, wherein at least one of the further polymeric components can have liquid-conducting microfluidic structures. A microfluidic valve can be realized by the separation of two liquid-conducting structures by a pneumatically caused deflection of the membrane into an advantageously designed partial volume of the liquid-conducting microfluidic structure provided for this purpose. A microfluidic pumping chamber, similar to a valve, can also be based on a displacement of liquids from a dedicated region of a liquid-bearing structure of the treatment apparatus. By contrast to valves, a pumping chamber, for example, can have a larger volume than a valve and can be used, for example, to temporarily hold defined liquid volumes, in particular to hold a significant portion or nearly the total volume of a liquid to be processed in a step of microfluidic discharge.

For example, a microfluidic pumping chamber can be used in combination with two microfluidic valves enclosing the pumping chamber in an advantageous manner so as to realize a pumping device, which can also be referred to as a pumping unit, which allows as great a flow rate as possible in the microfluidic treatment apparatus in as compact a space as possible. This can be achieved, for example, by the formation of the pumping device from a pumping chamber with a large displacement volume, which is used for pumping, that is to say for the directed displacement of liquids, and two valves with a small displacement volume, which are only used for defining and establishing the pumping direction by a suitable actuation scheme. Advantageously, this pumping device can be characterized by a large pumping volume per pumping step, as well as by a small space requirement for the realization of the pumping unit and a pulsatile, that is to say greatly temporally volatile, flow rate profile.

In order to, in particular, induce a pumping at a flow rate that is as constant and non-variable as possible, a peristaltic pumping through a peristaltic actuation of at least three homogeneous active microfluidic elements can be suitable, wherein the at least three active microfluidic elements can have a similar volume and nearly the same volume. A peristaltic pumping with three similar, active microfluidic elements can be achieved independent of their same displacement volume, i.e. in particular by the use of microfluidic valves, which can have a small displacement volume, or by the use of microfluidic pumping chambers, which can in particular have a larger displacement volume. Consequently, with respect to peristaltic liquid transport, a conceptual distinction between “valve” and “pumping chamber” is unnecessary. The conceptual separation is only useful if, like a variant of the treatment apparatus presented herein, there is a multifunctional use of the microfluidic elements: A microfluidic element, which, in addition to producing a peristaltic liquid transport, is primarily used in order to control the microfluidic flow within the microfluidic treatment apparatus, is therefore hereinafter referred to as a microfluidic valve. A microfluidic element, which, in addition to producing a peristaltic liquid transport, is used primarily to generate the microfluidic flow as well as for the interim storage of a significant part of the liquid volume to be processed within the microfluidic apparatus, is therefore referred to hereinafter as a microfluidic pumping chamber. Depending on the functionalities used of a microfluidic element, an advantageous configuration is carried out: A microfluidic valve, and in particular a microfluidic control or isolating valve, that is to say a microfluidic valve used exclusively for controlling the microfluidic flow or for separating liquid-conducting structures and not for peristaltic liquid transport, therefore has as little displacement volume as possible in particular, namely in order to, on the one hand, have as low a volume of liquid as possible, which can be flushed in a microfluidic drain, if necessary, and on the other hand, to achieve the most compact possible implementation of the microfluidic apparatus. By contrast, a pumping chamber, which can in particular be used for the defined storage and measurement of liquids, has in particular a predetermined displacement volume, for example 20µl, which substantially corresponds to the volume of liquid to be processed, or at least a significant fraction thereof.

In the treatment apparatus presented herein, the filter chamber arranged in the filtering branch is configured so as to accommodate a filter element, which can also be referred to as a filter. For example, the filter chamber can have a volume of 3 µl to 20 µl, preferably 5 µl to 10 µl, and can be enclosed by two filter valves having a displacement volume of, for example, 80 nl to 1 µl, preferably 100 nl to 300 nl. In this manner, the result is an advantageously as low as possible volume of the filtering branch, thereby enabling a particularly efficient microfluidic processing, in particular in connection with the purification of a sample liquid.

For example, the filter element can be a silica filter usable for the extraction of nucleic acids. For example, when using the treatment apparatus, different buffer solutions can be pumped via the filter element, so as to enable a binding of the nucleic acids to the silica filter, for example with a so-called binding buffer, or to achieve a dissolving of the nucleic acids bound to the silica filter with a so-called elution buffer, or to cause with a so-called wash buffer a flushing of the silica filter between the binding and dissolving of the nucleic acids.

Advantageously, the treatment apparatus allows for a microfluidic processing for purification of a sample liquid using a filter element having only low dead volumes. For example, the sample liquid can be aqueous solutions with sample material contained therein, in particular with sample material of human origin derived from, for example, bodily fluids, swabs, secretions, sputum, or tissue samples. The targets to be detected in the sample liquid can, in particular, be of medical, clinical, therapeutic, or diagnostic relevance and can, for example, be bacteria, viruses, specific cells, such as circulating tumor cells, cell-free DNA, or other biomarkers.

For example, with a variant of the microfluidic treatment apparatus presented herein, an amount of wash buffer that can undesirably enter the elution buffer can be reduced. In this manner, a particularly high efficiency in the purification of a sample liquid can be achieved.

Because, in addition to the nature of the filter element, the chemical composition of the buffer solutions used and the nature of the sample liquid as well as the constituents to be extracted also play a key role in the extraction efficiency, the treatment apparatus presented herein is advantageously configured so as to enable a particularly efficient purification of a sample or a sample liquid. To this end, the channel system, which can also be referred to as a channel, can be formed in the shape of a ring or loop, for example, wherein the filter chamber arranged in the channel system, the at least one pumping chamber, and the different valves are, or can be, fluidically coupled to the channel system. The first channel-crossover element arranged in the channel system is preferably formed in a T-shape, wherein the channel inlet, the filtering branch, and the pumping branch are connected to a different port of the first channel-crossover element and thus are, or can be, coupled to one another. In the same way, the second channel-crossover element is also preferably formed in a T-shape and forms a connection between the channel outlet, the filtering branch, and the pumping branch, which are also connected to another port of the second channel-crossover element. For example, the cross-sectional area of a microfluidic channel in the channel system as well as the cross-sectional area of the connections to the channel system can be 0.2 × 0.2 mm² to 2 × 2 mm², preferably 0.3 × 0.3 mm² to 0.8 × 0.8 mm^{2.}

The treatment apparatus can advantageously be manufactured inexpensively from polymer materials such as polycarbonate (PC), polypropylene (PP), polyethylene (PE), cyclic olefin copolymer (COP, COC) or polymethyl methacrylate (PMMA), for example by the use of high throughput techniques such as injection molding, thermoforming, or punching, wherein they can be obtained for example by laser transmission welding. The liquid transport within the microfluidic treatment apparatus can be achieved in a particularly simple manner by deflecting a flexible polymeric membrane into liquid-conducting recesses of a rigid polymeric component, such that a controlled displacement of liquids within the microfluidic treatment apparatus, in particular by applying different pressure levels to a pneumatic interface of the treatment apparatus, can be achieved. For example, thermoplastic elastomers (TPE) such as polyurethane (TPU) or styrene block copolymer (TPS) can be used as a flexible membrane. A micro-structuring of the flexible membrane can occur, for example, by punching. For example, the liquids usable in the treatment apparatus can be aqueous solutions or buffer solutions, as well as fluorinated hydrocarbons such as fluorinated 3M, for example for sealing microcavities and also oils such as mineral, paraffin, or silicone oils, for example for the production of multiphase systems in the treatment apparatus. The liquids can be introduced into the treatment apparatus, for example, during the manufacture of the treatment apparatus, for example filled and packaged in reactant bars, which permit long-term stable storage of the liquids in the treatment apparatus.

According to one embodiment, the pumping device can have two, in particular three, pumping chambers arranged or connected in a row adj acent to one another. For example, these can be three similar pumping chambers arranged in series on the microfluidic channel, which can also be referred to as chambers. For example, the pumping chambers can be suitable for producing a flow in the channel system and in particular through the filter chamber and can respectively be configured to hold a defined volume of liquid. In doing so, the pumping chambers can be separable from the channel system by two pumping valves surrounding the two outer valves of the three pumping chambers. Advantageously, such a defined volume of liquid within the three pumping chambers, including the connection channels between the chambers, can be pumped back and forth without a liquid exchange with the remaining portion of the microfluidic network. Furthermore, through a suitably controlled actuation of the two or three pumping chambers, a liquid transport can be achieved through the microfluidic channel system, and in particular through the filtering chamber, wherein the volume of liquid transported in a pumping step can correspond to the displacement volume of a pumping chamber. Depending on the actuation scheme selected, the liquid transport in the microfluidic channel system can be unidirectional or bidirectional.

According to a further embodiment, the pumping device can have a further pumping chamber, wherein the further pumping chamber is, or can be, separated by at least one pumping valve from the pumping chambers connected in series. For example, the further pumping chamber can be connected in series with the remaining pumping chambers of the pumping device, wherein the further pumping chamber can be separable from the channel system by, for example, two microfluidic pumping valves. Advantageously, the further pumping chamber can be used in combination with the other pumping chambers for optimized liquid transport in the microfluidic channel system, wherein the volume of liquid transported in a pumping step can correspond to the displacement volume of two pumping chambers. In this manner, for example, a pump can be achieved as part of an elution step by means of four pumping chambers, wherein the processed volume of liquid elution buffer can substantially correspond to the displacement volume of two pumping chambers. Following the elution, for example, after dissolving a reagent for performing a polymerase chain reaction with an eluate, an amplification reaction can then be carried out in three pumping chambers which are separated by two valves and respectively suitably heated, wherein the volume of liquid used in the polymerase chain reaction can substantially correspond to the displacement volume of a pumping chamber. Subsequently, a dilution and/or addition of further reagents can be enabled in turn, such that the volume of liquid can again substantially correspond to the displacement volume of two pumping chambers. Overall, this embodiment has the advantage that a high flexibility can be achieved in the execution of microfluidic procedures, for example for performing molecular diagnostic testing.

Advantageously, providing different pump rates and flow rate profiles can improve the efficiency of purification by optimizing the pump rates, particularly the pump rates, which are used for the processing of the filter element and a liquid flow through the filter element, respectively. In particular, depending on the filter material used and the composition of the buffer solutions, an optimized pumping protocol for microfluidic processing can be determined and used. For example, an especially low flow rate can reduce shear forces acting on constituents present in the sample liquid.

According to a further embodiment, each of the pumping chambers connected in series and the further pumping chamber can have a volume of substantially the same size. For example, a displacement volume of a pumping chamber can be 10 µl to 50 µl, in particular 15 µl to 25 µl. The pumping chambers can have a volume of the same size each within a tolerance range of 5%, for example. By contrast to the pumping chambers, the pumping valves of the pumping device can have a displacement volume of 200 nl to 3 µl, in particular 500 nl to 2 µl. Advantageously, through a suitably controlled actuation of the pumping chambers, a peristaltic pumping process can be favored, wherein the volume of liquid transported in a pumping step can correspond to the displacement volume of a pumping chamber.

Advantageously, the treatment apparatus allows for a microfluidic processing of variable liquid volumes. Through a combination of pumping valves and pumping chambers, i.e. microfluidic elements for generating a flow which have at least two different displacement volumes, for example, both a particularly precise liquid transport of particularly small and precisely definable volumes at a low flow rate, using the pumping valves, as well as a particularly fast liquid transport of large volumes at a greater flow rate, using at least one pumping chamber, are possible. In this manner, the treatment apparatus presented herein is advantageously particularly versatile and universally usable.

According to a further embodiment, at least two of the pumping chambers connected in series can each be independently temperature-controlled. The pumping chambers can be brought to different temperatures, for example by means of a temperature control unit, substantially independently of one another. For example, the first of three pumping chambers arranged in a row can be brought to a temperature of between approximately 94 to 96° C., for example 95° C., the second pumping chamber to a temperature of between 68 to 72° C., for example 70° C., and the third pumping chamber to a temperature of between 55 to 65° C., for example 60° C. Advantageously, the performance of a polymerase chain reaction, for example, in a volume of liquid delimited by pumping valves and substantially predetermined by the size of the pumping chambers, can be carried out by reciprocating pumps between the pumping chambers of different temperatures.

According to a further embodiment, the treatment apparatus can have a channel system expansion module that is, or can be, fluidically coupled to the pumping branch, wherein the channel system expansion module can have at least one upstream arrangement chamber for the upstream arrangement of reagents and additionally or alternatively at least one evaluation chamber having evaluation cavities for evaluating sample constituents of a sample liquid. When using an external analysis device to analyze the evaluation cavities, an evaluation signal can be provided using the treatment apparatus presented herein. For example, the upstream arrangement chamber can be usable for the upstream arrangement of dry reagents. In this manner, for example, a lyophilisate, which can also be referred to as a bead and which can be provided for the treatment of a reaction liquid or a reaction mix, for example for the performance of a polymerase chain reaction, can be arranged upstream in this upstream arrangement chamber. For example, the dry reagent can be dissolved following purification of a sample of at least a portion of an obtained eluate, in order to produce a reaction liquid, which, by means of the filter element, contains purified sample material and then, for an amplification of in particular constituents of the sample material, such as certain DNA sequences, for example using the aforementioned arrangement of pumping chambers, can be used in order to subsequently enable a fluorescence or chemiluminescence-based detection of these constituents of the sample material, for example. The evaluation chamber can have, for example, a chip with an array of microcavities and can form a flow cell for microfluidic processing of the chip with the microcavities. For example, the so-called array chip can consist substantially of silicon made from silicon plates (“silicon wafers”) by lithographic methods, etching, coating, and separating. For example, target-specific reagents can be arranged upstream in the microcavities, which can allow different targets in a liquid to be detected, for example, by geometric multiplexing, wherein the reagents can be introduced into the microcavities by means of a fine-dispensing system, for example. Advantageously, using the channel system expansion module, a sample liquid can thus be investigated for a variety of different features.

According to a further embodiment, the upstream arrangement chamber is, or can be, fluidically coupled to the pumping branch by means of a channel connecting element that can be sealed with an upstream arrangement valve, and the evaluation chamber is, or can be, fluidically coupled to the pumping branch by means of a further channel connecting element that can be sealed with an evaluation valve. For example, the upstream arrangement valve and the evaluation valve can be closed while a sample liquid is being processed within the pumping branch. Advantageously, processes can thereby be limited to a region of the channel system necessary for the drainage.

According to a further embodiment, the pumping device can have a single pumping chamber and at least three pumping valves. For example, the three pumping valves can be actuable independently and can be used by actuation according to a peristaltic scheme for producing a flow in the microfluidic channel system, and in particular the filter chamber. Advantageously, the pumping device can thus be formed in a particularly space-saving manner.

According to a further embodiment, an inlet valve can be arranged between the channel inlet and the first channel-crossover element and, additionally or alternatively, an outlet valve can be arranged between the channel outlet and the second channel-crossover element. For example, by using both an inlet valve and an outlet valve, it can be possible to separate the channel inlet and the channel outlet of the, for example loop-shaped, microfluidic channel system, including the filter chamber with the filter element, from a remaining microfluidic network. In this manner, advantageously, an in-circle-pumping can be achieved within the microfluidic channel system across the filter chamber without a liquid exchange with the remaining portion of the microfluidic network.

In addition, a method for operating a variant of a microfluidic treatment apparatus described above is presented, as also described above. The method comprises a step of introducing a sample liquid into the microfluidic treatment apparatus, a step of extracting or purifying sample constituents present in the sample liquid through a filter element, and a step of eluting sample constituents from the filter element. Eluting can be understood to mean a debonding of sample constituents from the filter element. With such an embodiment of the approach presented herein, the aforementioned advantages can be realized in a technically simple and inexpensive way.

According to one embodiment, the method can have an additional step of lysing constituents of the sample liquid following the step of insertion and prior to the step of extraction, and, additionally or alternatively, a step of washing the filter element and, additionally or alternatively, the filter chamber following the step of extraction and prior to the step of elution. With such an embodiment, a significant improvement in the analysis of the sample liquid can be achieved.

Furthermore, the method can have an additional step of providing a reaction liquid by dissolving a reagent using the sample constituents following the step of elution. Additionally or alternatively, the method can have an additional step of performing an amplification reaction, and, additionally or alternatively, an additional step of aliquoting the reaction liquid, and, additional or alternatively, an additional step of performing a detection reaction, and, additionally or alternatively, an additional step of evaluating a reaction result. Also with such an embodiment, a significant improvement in the analysis of the sample liquid can be achieved.

This method can be implemented, for example, in a software or hardware or in a mixed form of software and hardware, for example in a control unit.

The approach presented here furthermore creates a control unit which is designed to carry out, control, or change the steps of a variant of a method presented here in corresponding devices or units. This embodiment variant of the invention in the form of a control unit can also quickly and efficiently achieve the problem underlying the invention.

For this purpose, the control unit can have at least one computing unit for treating signals or data, at least one storage unit for storing signals or data, at least one interface to a sensor or an actuator for reading sensor signals from the sensor or for outputting control signals to the actuator, and/or at least one communication interface for reading or outputting data embedded in a communication protocol. For example, the computing unit can be a signal processor, a microcontroller, or the like, wherein the storage unit can be a flash memory, an EEPROM, or a magnetic storage unit. The communication interface can be designed to read or output data in a wireless and/or wired manner, wherein a communication interface capable of reading or outputting wired data can, for example, electrically or optically read said data from a corresponding data transmission line or output them into a corresponding data transmission line.

In the present case, a control unit is understood to mean an electrical device that processes sensor signals and outputs control signals and/or data signals as a function thereof. The control unit can have an interface, which can be formed by hardware and/or software. In a hardware design, the interfaces can, for example, be part of a so-called system ASIC, which contains various functions of the control unit. However, it is also possible that the interfaces are separate, integrated circuits or at least partially consist of discrete structural elements. In a software design, the interfaces can be software modules that are present, for example, on a microcontroller in addition to other software modules.

A computer program product or a computer program with program code that can be stored on a machine-readable carrier or storage medium, such as a semiconductor memory, a hard disk memory, or an optical memory, and that is used for performing, implementing, and/or controlling the steps of the method according to one of the embodiments described above is advantageous as well, in particular when the program product or program is executed on a computer or an apparatus.

Embodiment examples of the approach presented herein are illustrated in the drawings and explained in further detail in the following description. The following are shown:

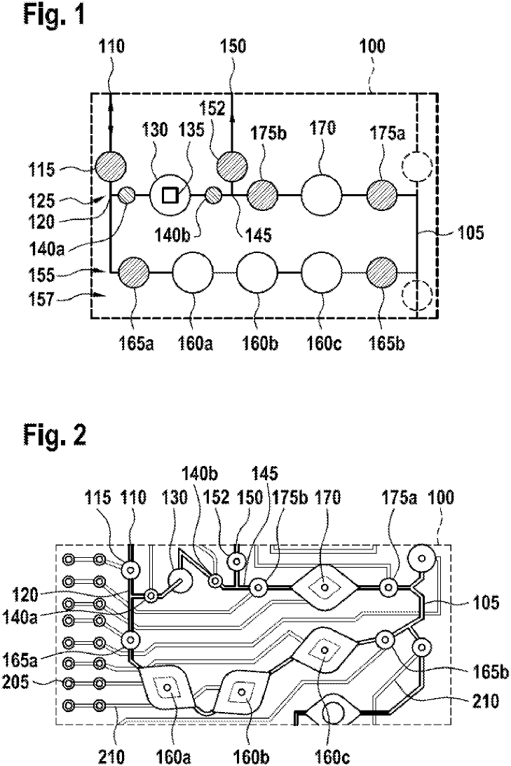

FIG. 1 a schematic representation of an embodiment example of a treatment apparatus;

FIG. 2 a schematic plan view of an embodiment example of a treatment apparatus;

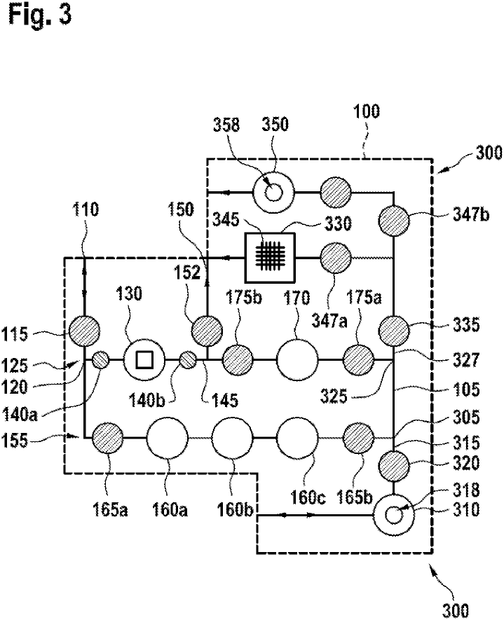

FIG. 3 a schematic representation of an embodiment example of a treatment apparatus having a channel system expansion module;

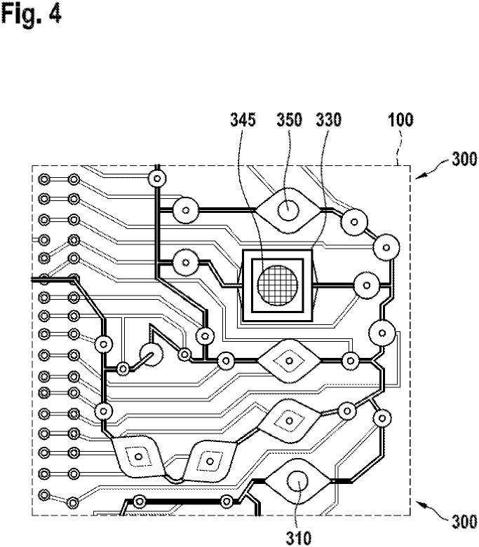

FIG. 4 a schematic plan view of an embodiment example of a treatment apparatus having a channel system expansion module;

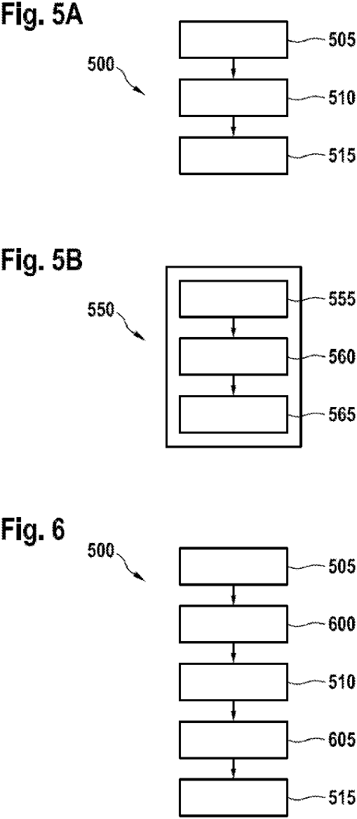

FIG. 5A a flow chart of an embodiment example of a method for operating a microfluidic treatment apparatus;

FIG. 5B a block diagram of a control unit for operating a microfluidic treatment apparatus according to a variant presented herein;

FIG. 6 a flowchart of an embodiment example of a method for operating a microfluidic treatment apparatus, with an additional step of lysing and an additional step of washing; and

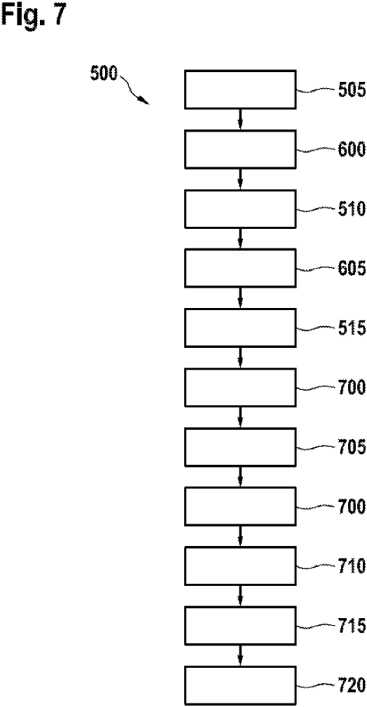

FIG. 7 a flowchart of an embodiment example of a method for operating a microfluidic treatment apparatus having a channel system expansion module.

In the following description of favorable embodiment examples of the present invention, identical or similar reference numbers are used for the elements shown in the various figures and acting similarly, wherein a repeated description of these elements is dispensed with. If an embodiment example encompasses an “and/or” conjunction between a first feature and a second feature, this is to be read such that the embodiment example according to one embodiment example has both the first feature and the second feature and according to a further embodiment example has either only the first feature or only the second feature.

FIG. 1 shows a schematic representation of an embodiment example of a treatment apparatus 100. In this embodiment example, the treatment apparatus 100 is configured with lateral dimensions of 45 × 25 mm². The treatment apparatus 100 in this embodiment example has a microfluidic channel system 105 for accommodating a sample liquid, that is to say a liquid having constituents of a sample. The cross-sectional area of the channel system 105 in this embodiment example is 0.4 × 0.6 mm². In a further embodiment example, the channel system is formed with a cross-sectional area of 0.8 × 0.8 mm². In this embodiment example, the sample liquid is introduced into the treatment apparatus 100 via a channel inlet 110, wherein the channel inlet 110 forms a connection to a microfluidic network, not shown in this figure. The channel inlet 110 can be separated from the remaining areas of the treatment apparatus 100 by means of an inlet valve 115. In this embodiment example, the inlet valve 115 is arranged between the channel inlet 110 and a first channel-crossover element 120, wherein the first channel-crossover element 120 preferably has a T-shape. While the channel inlet 110 is fluidically coupled to a port of the first channel-crossover element 120 via the isolating valve 115, another port of the first channel-crossover element 120 is fluidically coupled to a filtering branch 125 of the treatment apparatus 100. The filtering branch 125 has a filter chamber 130 in which, in this embodiment example, a filter element 135 is arranged, wherein the filter chamber 130 can be used for extracting sample constituents, which can also be referred to as constituents of a sample. A first filter valve 140a is arranged between the filter chamber 130 and the first channel-crossover element 125. Additionally, a second filter valve 140b is arranged between the filter chamber 130 and a second channel-crossover element 145. By means of the first filter valve 140a and the second filter valve 140b, the filter chamber 130 is separable from the remaining regions of the treatment apparatus 100. In other words, two filter valves 140a, 140b, which can also be referred to as microfluidic switching valves, are arranged on the microfluidic channel in as close proximity to the filter chamber 130 as possible on either side of the filter chamber 130, such that a closing of the two filter valves 140a, 140b separates the filter chamber 130 from the channel. In this embodiment example, the filter valves 140a, 140b have a particularly low volume so as to minimize the volume around the filter chamber 130. The filter valves 140a, 140b are merely aligned by way of example, so that they can be actuated together via exactly one pneumatic control channel.

Accordingly, the treatment apparatus 100 is characterized by a particularly advantageous arrangement and configuration of the microfluidic elements for a filter-based purification of a sample liquid, in particular by implementing an in particular loop-shaped microfluidic channel system 105, which contains a filter chamber 130 having a filter element 135, wherein the filter chamber 130 can be liquid-tightly separated from the remaining portion of the microfluidic channel system 105 by two microfluidic filter valves 140a, 140b. The two microfluidic filter valves 140a, 140b are in particular actuated together in order to achieve a particularly simple and compactly viable pneumatic control. The treatment apparatus 100 also has two preferably T-shaped channel-crossover elements 120, 145, which are arranged in the as immediate as possible vicinity of the two filter valves 140a, 140b surrounding the filter chamber 130, which can also be referred to as isolating valves, and form exactly two microfluidic bonds to the microfluidic channel system 105, such that, particularly when closing the isolating valves 140a surrounding the filter chamber 130, 140b, a flushing of the remaining part of the microfluidic channel system 105 via the connections is enabled.

With the second filter valve 140b open, the filter chamber 130 is fluidically coupled to a channel outlet 150 connected to a further port of the second channel-crossover element 145 via a port of the second channel element 145. In this embodiment example, the channel outlet 150 forms a link to a collection chamber not shown in the figure, wherein the channel outlet 150 can be used for dispensing the sample liquid after the extraction of constituents through the filter element 135. In doing so, the channel outlet 150 is separable from the remaining regions of the treatment apparatus 100 while congruent with the channel inlet 110 with an outlet valve 152. The first channel-crossover element 120 and the second channel-crossover element 145, both of which can also be referred to as channel-crossovers, accordingly enclose the filter chamber 130 and the two filter valves 140a, 140b arranged about the filter chamber 130, which can also be referred to as switching valves. In this manner, the result is an as low as possible volume of the filtering branch 125, thereby enabling a particularly efficient microfluidic processing, in particular in connection with the purification of a sample liquid.

A pumping branch 155 is connected to the filtering branch 125 in parallel with a pumping device 157, wherein the pumping branch 155 is fluidically coupled to the channel inlet 110 via a port of the first channel-crossover element 120 other than the filtering branch 125 and fluidically coupled to the channel outlet 150 via a port of the second channel-crossover element 145 other than the filtering branch 125. In this embodiment example, the filtering branch 125 and the pumping branch 155 form a loop-like, closable system via the connection through the channel system 105. In this embodiment, on the one hand, the pumping branch 155 has at least two, here exactly three pumping chambers 160a, 160b, 160c, which are directly adjacent to one another. The pumping chambers 160a, 160b, 160c in this embodiment example are arranged in series along the microfluidic channel system 105 and are thus connected in series and have nearly the same volume. By way of example only, they are fluidically separable from the remaining regions of the treatment apparatus 100 via two microfluidic pumping valves 165a, 165b surrounding the three pumping chambers 160a, 160b, 160c.

The row-shaped arrangement of the pumping chambers 160a, 160b, 160c and the pumping valves 165a, 165b on the loop-like microfluidic channel system 105, which can be used for conveying liquids through the filter chamber 130 and within the microfluidic channel system 105, allow for a peristaltic pumping operation. In this embodiment example, the pumping chambers 160a, 160b, 160c are further individually, that is, substantially independently of one another, temperature-controlled. In this manner, the three pumping chambers 160a, 160b, 160c can be used in addition to the controlled accommodation of sample liquid and the generation of a microfluidic flow in the channel system 105, in particular in the context of a purification of a sample liquid using the filter chamber 130 with the filter element 135 for carrying out, for example, a polymerase chain reaction. Following a purification of the sample liquid, the pumping chambers 160a, 160b, 160c thus also allow for an amplification of purified sample material in the treatment apparatus 100.

On the other hand, this embodiment has a further pumping chamber 170, wherein each of the pumping chambers 160a, 160b, 160c and the further pumping chamber 170 connected in series have a substantially equal volume, so that a total of four similar pumping chambers 160a, 160b, 160c, 170 are present. In this manner, a particularly flexible processing of liquid volumes is possible, which substantially correspond to the displacement volume of up to two of the pumping chambers 160a, 160b, 160c, 170, such that a performance of various steps of a test sequence within the treatment apparatus 100 is advantageously achievable. In this embodiment example, the further pumping chamber 170 can also be separated from the remaining regions of the treatment apparatus 100 by two further pumping valves 175a, 175b. In this respect, both the pumping valves 165a, 165b and the further pumping valves 175a, 175b are designed for use as peristaltic pumping valves in addition to the function of separation, and therefore have a greater displacement volume than the first filter valve 140a and the second filter valve 140b, which are configured so as to disconnect the filter chamber 130 from the remaining regions of the treatment apparatus 100.

FIG. 2 shows a schematic plan view of an embodiment example of a treatment apparatus 100. This can be the treatment apparatus described in FIG. 1.

In this embodiment example, the treatment apparatus 100 is based on a flexible, microstructured polymer membrane, which has been in particular partially welded to two microstructured polymer components by laser welding, which can also be referred to as laser transmission welding. In the rigid polymeric components, in particular, there are liquid-conducting recesses that realize the microfluidic passages of the channel system 105, the pumping chambers 160a, 160b, 160c, the further pumping chamber 170, the pumping valves 165a, 165b, the further pumping valves 175a, 175b, the filter valves 140a, 140b, the inlet valve 115, and the outlet valve 152. Further, at least one of the components has in particular pneumatic channels 210 which are used for controlling the active microfluidic elements, in particular the pumping chambers and the valves. The controlling of the microfluidic elements in this embodiment example is accomplished by a pressure-based locally defined deflection of the elastic membrane into the recesses of the polymeric components forming the valves and pumping chambers. At least two pressure levels are used for controlling the microfluidic elements. In particular, the pressure levels are controlled and provided by an external processing unit having a pneumatic interface 205 to the treatment apparatus 100. By way of example only, the interface 205 in this figure is arranged on the left edge of the figure. The pneumatic channels 210 used in order to control the microfluidic elements are shown in red in this figure. The microfluidic channels of the channel system 105 and the filter chamber 130 are shown in blue, and the pneumatically controllable microfluidic elements are visualized in red like the pneumatic channels 210.

FIG. 3 illustrates a schematic representation of an embodiment example of a treatment apparatus 100 having a channel system expansion module 300. This can be the treatment apparatus described in the previous figures.

In this embodiment, the pumping chambers 160a, 160b, 160c arranged in a row can be independently temperature-controlled by means of a temperature-control device, not shown. Merely by way of example, the first of the three pumping chambers 160a is brought to a temperature of 95° C., the second pumping chamber 160b is brought to a temperature of 70° C., and the third of the three pumping chambers 160c is brought to a temperature of 60° C. In this manner, carrying out a polymerase chain reaction within a volume of liquid pumped back and forth periodically between the three pumping chambers 160a, 160b, 160c is enabled. In this embodiment example, the series of pumping chambers 160a, 160b, 160c can be separated from the microfluidic channel system 105 by two microfluidic pumping valves 165a, 165b. In this manner, a particularly efficient back-and-forth pumping and temperature-control of the liquid plug in the three pumping chambers 160a, 160b, 160c are possible, wherein liquid losses are prevented by the separation of the unit from three pumping chambers 160a, 160b, 160c by means of the microfluidic pumping valves 165a, 165b, and the liquid chambers 160a, 160b, 160c adj acent to the pumping are minimized with the dead volumes of the thermal and microfluidic processing of the liquid volume.

In this embodiment example, the pumping branch 155 is fluidically coupled to an upstream arrangement chamber 310 via an additional preferably T-shaped channel-crossover element 305. By way of example only, the upstream arrangement chamber 310 is used in order to arrange freeze-dried reagents upstream. An upstream arrangement valve 320 is arranged between the additional channel-crossover element 305 and the upstream arrangement chamber 310 at a channel connecting element 315, wherein the upstream arrangement valve 320 is configured so as to separate the upstream arrangement chamber 310 from the pumping branch 155. Thus, in this embodiment example, the channel connecting element 315 establishes a connection between the pumping branch 155 and the microfluidic upstream arrangement chamber 310 that can be closed with the upstream arrangement valve 320, which upstream arrangement chamber contains at least one upstream reagent 318, in particular a so-called bead, which can also be referred to as a lyophilisate and which is suitable for the provision of a reaction liquid using an eluate, that is to say the liquid which is obtained from a purification of the sample liquid using the treatment apparatus 100 and the filter element 135 described in FIG. 1. In other words, a reaction liquid, which can also be referred to as a reaction mix, is provided by dissolving a bead in the microfluidic upstream arrangement chamber 310 by means of the eluate previously obtained from a purification. The upstream arrangement chamber 310 is, merely by way of example, pneumatically actuatable and thus comparable to the remaining pumping chambers 160a, 160b, 160c so as to also provide a pumping action with the upstream arrangement chamber 310.

In this embodiment example, the microfluidic channel system 105 between the additional channel-crossover element 305 and the further pumping valve 175a has a further preferably T-shaped channel-crossover element 325 having a further channel connecting element 327 via which the pumping branch 155 is fluidically coupled to an evaluation chamber 330. The further channel connection element 327 can be closed with an evaluation valve 335. The evaluation chamber 330, which can also be referred to as an array chamber, in this embodiment example has a chip having an array of evaluation cavities 345, which can also be referred to as microcavities. Only exemplary target-specific reagents are arranged upstream in the evaluation cavities 345, which allow a detection of different targets in the liquid by geometric multiplexing. In this manner, a sample can be investigated for a variety of different features using the channel system expansion module 300. The microfluidic valves 347a, 347b, which are in particular intended for microfluidic processing of the evaluation chamber 330 by means of peristaltic pumps, have, merely by way of example, a displacement volume designed for this purpose. In this embodiment example, the displacement volume of the microfluidic valves 347a, 347b exceeds the volume of the pumping valves 165a, 165b which are used for a peristaltic pump in the pumping branch 155. In this manner, a higher flow rate can be generated with the valves 347a, 347b, whereas the pumping valves 165a, 165b have a smaller space requirement and therefore allow as compact a realization of the apparatus as possible. Further, this embodiment example additionally comprises access to a further upstream arrangement chamber 350, which can also be referred to as a bead chamber, in which there is a further freeze-dried reagent 358, which can be used, merely by way of example, for producing a reaction liquid for multiplexed detection in the chip with the evaluation cavities 345.

In other words, this embodiment example has additional microfluidic elements, which can in particular be used for further sample analysis of the sample material purified by the treatment apparatus 100. In addition to the integration of further chambers for an upstream arrangement of further dry reagents, for example constituents for carrying out further detection and/or amplification reactions, the treatment apparatus 100 in this embodiment example has a unit for aliquoting or partitioning the processed sample liquid. In a particularly advantageous manner, by an upstream arrangement of further dry reagents in the evaluation cavities 345 for aliquoting in the individual aliquots, different detection reactions for addressing different targets in the sample liquid can be carried out independently of one another. In this manner, which can also be referred to as geometric multiplexing, a sample liquid can be examined for the presence of a variety of different features. In a further embodiment example, the chip having the evaluation cavities 345 permits microfluidic generation of a particularly high number of aliquots of the processed sample liquid, in particular more than 1000 partitions. In this manner, digital sample analysis is enabled. In doing so, approximately a copy number of targets initially present in a sample liquid can be quantified with absolute accuracy.

FIG. 4 illustrates a schematic plan view of an embodiment example of a treatment apparatus 100 having a channel system expansion module 300. This can be the treatment apparatus described in the previous figures and the channel system expansion module described in FIG. 3.

In this embodiment example, the treatment apparatus 100 comprises an upstream arrangement chamber 310, a further upstream arrangement chamber 350, and an evaluation chamber 330, which is provided for accommodating and microfluidically processing a chip having evaluation cavities 345.

In this embodiment example, the microfluidic treatment apparatus 100 is inclined against the direction of action of a gravitational field at an angle of about 30°. In a further embodiment example, the treatment apparatus 100 is oriented at a predetermined angular range of between 0° and 45° to the field lines of the earth gravitational field with a gravity acceleration of approximately 9.81 m/s². With a suitable orientation of the upstream arrangement chamber 310 and the adjacent microfluidic channels in the treatment apparatus 100, it is achieved that gas bubbles which form upon dissolution of the reagent are discharged due to the buoyancy acting on the gas bubbles due to the density difference compared to the surrounding liquid, driven by gravity, whereas the reaction liquid is free of gas bubbles and further usable. The reaction liquid can then be used, for example, to carry out a polymerase chain reaction in the treatment apparatus 100 so as to amplify constituents of the eluate, which are, merely by way of example, predetermined nucleic acid sequences, and to thus make them accessible for a subsequent detection reaction. The subsequent detection reaction in this embodiment example is an amplification reaction, which is carried out in an array format in order to detect different targets based on a fluorescence signal. In a further embodiment example, the subsequent detection reaction is a hybridization reaction, which is carried out in an array format in order to detect different targets based on a bioluminescence signal.

FIG. 5A is a flow chart of an embodiment example of a method 500 for operating a microfluidic treatment apparatus. This can be the treatment apparatus described in the previous figures.

The method 500 has a step 505 of introducing a sample liquid into the microfluidic treatment apparatus. In addition, the method 500 has a step of extraction 510 sample constituents present in the sample liquid through a filter element, wherein a connection of constituents present in the sample liquid, which in this embodiment example are nucleic acids, is made to the filter element located in the filter chamber. In order to improve or allow a binding of the constituents to the filter, this step is carried out, merely by way of example, by pumping a binding buffer. As described above, the extraction and an optional subsequent step of washing the filter element via channel inlet 110, filtering branch 125, and channel outlet 150 can occur, wherein no liquid or as little liquid as possible is directed into the pumping branch 155, in particular by closing the pumping valves 165a, 165b, and preferably also by closing the further pumping valves 175a, 175b. In addition, the method 500 has a step of elution 515 sample constituents from the filter element. In doing so, sample components bound to the filter are dissolved. The elution can be carried out via a flushing through the pumping branch 155 and the filtering branch 125, in particular via a repeated, circular flushing, in particular when the inlet valve 115 and the outlet valve 152 are closed and when the pumping valves 165a, 165b and, if present, preferably the further pumping valves 175a, 175b are opened. This is merely by way of example, using an elution buffer in which the constituents are present after dissolving. In a further embodiment example, a flushing of the microfluidic channel with an elution buffer occurs prior to the actual elution, separating the filter chamber by means of the microfluidic filter valves in order to remove residues of the binding buffer and the wash buffer.

FIG. 5B shows a block diagram of an embodiment example of a control unit 550 for operating a microfluidic treatment apparatus according to a variant presented herein. The control unit comprises a unit 555 for controlling an introduction of a sample liquid into the microfluidic treatment apparatus. Further, the control unit 550 comprises a unit 560 for controlling an extraction of sample constituents present in the sample liquid through a filter element and a unit 565 for controlling an elution of sample constituents from the filter element.

FIG. 6 shows a flow chart of an embodiment example of a method 500 for operating a microfluidic treatment apparatus with an additional step of lysing 600 and an additional step of washing 605. This can be the method described in FIG. 5.

In this embodiment example, following step of insertion 505 and prior to step of extraction 510, there is a step of lysing 600 the sample liquid, in which a lysis of constituents present in the sample liquid, such as bacteria or cells, is carried out. The lysis is done, merely by way of example, by adding a lysis buffer to the sample liquid, wherein the lysis buffer mixed with the sample liquid is subsequently, in a step of extraction 510, conducted via the channel inlet 110, the filtering branch 125, and the channel outlet 150, in particular with the first pumping valve 165a closed and the further first pumping valve 175a closed, and an enrichment of sample constituents released during lysis, for example nucleic acids, can occur on the filter element. In a further embodiment example, the lysis is carried out by an ultrasonic effect. In addition, in this embodiment example, the method 500 has a step of washing 605 the filter element and the filter chamber following the step of extraction 510 and prior to the step of elution 515, wherein the step of washing 605 can occur as described above in FIG. 5 via the following short path: channel inlet 110 — filtering branch 125 — channel outlet 150. In the step of washing 605, in particular, residues of the binding buffer located in the vicinity of the filter chamber are removed and replaced by the washing buffer.

FIG. 7 illustrates a flow chart of an embodiment example of a method 500 for operating a microfluidic treatment apparatus having a channel system expansion module 300. This can be the method described in FIG. 5 and in FIG. 6.

In this embodiment example, the method 500 following the step of elution 515 has an additional step of providing 700 a reaction liquid by dissolving a reagent using the sample ingredients. The step of providing 700 a reaction liquid can also be referred to as a bead-dissolving step. At least a part of the previously obtained eluate is transferred to an upstream arrangement chamber described in FIG. 3 in order to dissolve a reagent upstream therein and to produce a reaction liquid for a first amplification reaction.

Additionally, in this embodiment example, the method 500 has a step of carrying out 705 an amplification reaction. The reaction liquid generated is, merely by way of example, heated cyclically in the treatment apparatus to two different temperature levels in two pumping chambers arranged in series and detachable by pumping valves, in particular in one or more of the pumping chambers 160a, 160b, 160c in the pumping branch 155. In this embodiment example, the temperature-control is used in order to carry out a multiplexed polymerase chain reaction.

In a further embodiment example, the step of carrying out 705 an amplification reaction is followed by a step of diluting the reaction liquid containing the reaction products from the first amplification reaction.

Further optionally, in a further embodiment example, after the step of carrying out 705 an amplification reaction, a step of temperature-control is carried out in order to cause a denaturation of constituents of the reaction liquid. Further optionally, in a further embodiment example, after the step of carrying out 705 an amplification reaction, a step of adding further reagents is carried out, for example in liquid or in solid form, for example freeze-dried or lyophilized.

In this embodiment example, after the step of carrying out 705 an amplification reaction, the step of providing 700 a reaction liquid is repeated. A portion of the diluted reaction liquid containing a portion of the reaction products from the first amplification reaction is used in order to thereby dissolve a further bead in the further upstream arrangement chamber and to produce a reaction liquid for carrying out a detection reaction.

In addition, in this embodiment example, the method 500 has an additional step of aliquoting 710 the reaction liquid. In doing so, a portion of the reaction liquid is distributed from the step of providing 700 a reaction liquid to at least two reaction compartments. For the generation of the reaction compartments, only a part of the liquid via the evaluation chamber described in FIG. 3 is transferred to the microcavities, and subsequently the microcavities are sealed by the introduction of a further liquid, which is not mixable with the reaction liquid, into the evaluation chamber, so that microfluidic reaction compartments, which are subsequently separated from one another and consist of parts, or aliquots, of the reaction liquid, are present in the microcavities. In the individual microcavities, in this embodiment example, target-specific reagents are arranged upstream so as to examine the present aliquoted liquid for the presence of different targets.

In this embodiment example, the method 500 additionally has a step of carrying out 715 a detection reaction, in particular in the evaluation chamber 330. The detection reaction is, merely by way of example, a second amplification reaction, specifically a polymerase chain reaction, wherein the microcavities and the microfluidic reaction compartments located therein are temperature-controlled so as to allow further amplification reactions to be carried out therein. In a further embodiment example, the detection reaction is an isothermal amplification variant.

In addition, in this embodiment example, the method 500 has an additional step of evaluating 720 a reaction result, in particular in the evaluation chamber 330. The evaluation is carried out, merely by way of example, using visual analysis of a fluorescence signal caused by probe molecules present in the individual reaction compartments. Based on the signal, the sample liquid can thus be tested for the presence of different target substances. In a further embodiment example, the step of evaluation 720 occurs in parallel to the carrying out 715 of a detection reaction.

In other embodiments of the method 500, individual steps can be carried out repeatedly, their order can be swapped, or they can be omitted entirely.

In other words, the treatment apparatus presented herein can be described as follows:

The treatment setup described in the preceding figures is characterized by a particularly high variability of the adjustable flow rates and pumping characteristics for the processing of the filter element, in particular by the use of at least two different types of active microfluidic elements for the generation of a flow. That is to say, in particular, by membrane-based elements having at least two different liquid displacement volumes, in particular suitably sized pumping chambers and pumping valves as described in the previous figures. In addition, the treatment setup has a suitable arrangement and number of microfluidic elements, in order to, for example, enable a peristaltic pumping with at least three elements, wherein the volume of liquid transported in a step corresponds to the displacement volume of an element, or in order to achieve, for example, a unidirectional or bi-directional pumping using four same elements, wherein the transportable volume of liquid corresponds to the displacement volume of two elements. In addition, in the treatment setup described in the preceding figures, a use of different actuation sequences of the microfluidic elements is possible, with an adjustable actuation frequency and sequence of actuation of the microfluidic elements, in order to enable a peristaltic pumping or shuttle pumps, in particular bidirectionally in the microfluidic channel and in particular through the filter chamber with the filter element. In addition, the treatment setup described in the preceding figures allows for a particularly advantageous connection of the treatment apparatus, which can also be referred to as the purification unit, to a microfluidic network as well as a particularly space-saving arrangement and efficient and repeated use of the microfluidic elements forming the purification unit. In particular, this can be realized by an implementation of three pumping chambers arranged in series in the microfluidic channel system, which can be separated from the microfluidic channel system and the microfluidic network surrounding the treatment apparatus by two valves adjacent to the two outer of the three pumping chambers, and which can in particular be temperature-controlled individually, that is to say substantially independently, of one another. In this manner, with a suitable temperature-control, the three isolated pumping chambers can be used in order to periodically bring a liquid plug therein to different temperatures, for example to carry out a polymerase chain reaction in the liquid plug.

In addition, the treatment setup described in the previous figures has a low dead volume, in particular of a wash buffer which undesirably reaches an elution buffer, in particular by an arrangement of the two filter valves surrounding the filter chamber with the filter element so as to be as spatially close as possible and the adjacent T-shaped channel-crossover elements and/or a minimization of the channel volume present therein.

In addition, the treatment setup described in the preceding figures is characterized by the possibility of processing variable liquid volumes, in particular by an implementation of a total of four pumping chambers in the purification unit, in order to process a liquid plug which has substantially the displacement volume of one or two of the pumping chambers in the purification unit. Also, the possibility of embedding the volume of sample liquid to be processed into a second non-mixable liquid phase can favor the treatment process.

1. A microfluidic treatment apparatus for treating a sample liquid, the microfluidic treatment apparatus comprising:
at least one microfluidic channel system having at least one filtering branch and a pumping branch connected in parallel with the filtering branch;
at least one filter chamber arranged in the filtering branch and is configured to accommodate a filter element;
a first channel-crossover element configured to fluidically couple the filtering branch to a channel inlet;
a second channel-crossover element configured to fluidically couple the filtering branch to a channel outlet;
at least two filter valves configured to fluidically isolate the filter chamber from the rest of the channel system ; and
a pumping device arranged in the pumping branch and configured to produce a fluidic flow in the channel system, the pumping device comprising at least one pumping valve and/or at least one pumping chamber,
wherein the pumping branch is configured to be coupled fluidically to the channel inlet via a first connection of the first channel-crossover element which is different from a second connection of the first channel-crossover element for the filtering branch, and the pumping branch is configured to be coupled fluidically to the channel outlet via a first connection of the second channel-crossover element which is different from a second connection of the second channel-crossover element for the filtering branch.

2. The treatment apparatus according to claim 1, wherein the at least one pumping chamber includes at least two first pumping chambers arranged or connected in a row adjacent to one another.

3. The treatment apparatus according to claim 2, wherein the at least one pumping chamber further includes a second pumping chamber configured to be separated from the at least two first pumping chambers by at least one pumping valve.

4. The treatment apparatus according to claim 3, wherein each of the at least two first pumping chambers and the second pumping chamber have a volume that is substantially the same size.

5. The treatment apparatus according to claim 2, wherein at least two of the at least two first pumping chambers are configured to be temperature-controlled independently of one another.

6. The treatment apparatus according to claim 1, further comprising:
a channel system expansion module configured to be fluidically coupled to the pumping branch the channel system expansion module comprising at least one upstream arrangement chamber configured for upstream arrangement of reagents and/or at least one evaluation chamber having evaluation cavities configured for evaluating sample constituents of a sample liquid.

7. The treatment apparatus according to claim 6, wherein:
the upstream arrangement chamber configured to be fluidically coupled to the pumping branch by a channel connecting element that be is closed with an upstream arrangement valve; and
the evaluation chamber is configured to be fluidically coupled to the pumping branch by a further channel connecting element that is closed with an evaluation valve.

8. The treatment apparatus (490) according to claim 1, wherein the the at least one pumping chamber comprises a single pumping chamber and the at least one pumping valve comprises at least three pumping valves.

9. The treatment apparatus according to claim 1, wherein an inlet valve is arranged between the channel inlet and the first channel-crossover element, and/or an outlet valve is arranged between the channel outlet and the second channel-crossover element.

10. A method for operating a microfluidic treatment apparatus having (i) at least one microfluidic channel system having at least one filtering branch and a pumping branch connected in parallel with the filtering branch, (ii) at least one filter chamber arranged in the filtering branch and configured to accommodate a filter element, (iii) a first channel-crossover element configured to fluidically couple the filtering branch to a channel inlet, (iv) a second channel-crossover element configured to fluidically couple the filtering branch to a channel outlet, (v) at least two filter valves configured to fluidically isolate the filter chamber from the rest of the channel system, and (vi) a pumping device arranged in the pumping branch and configured to produce a fluidic flow in the channel system, the pumping device comprising at least one pumping valve and/or at least one pumping chamber, the pumping branch configured to be coupled fluidically to the channel inlet via a first connection of the first channel-crossover element which is different from a second connection of the first channel-crossover element for the filtering branch, and the pumping branch configured to be coupled fluidically to the channel outlet via a first connection of the second channel-crossover element which is different from a second connection of the second channel-crossover element for the filtering branch the method comprising:
introducing a sample liquid into the microfluidic treatment apparatus;
extracting sample constituents present in the sample liquid through a filter element; and
eluting sample constituents from the filter element.

11. The method according to claim 10, further comprising:
lysing the sample liquid following the introduction of the sample liquid and before the extraction of the sample constituents; and/or
washing the filter element and the filter chamber following the extraction of the sample constituents and before the elution of the sample constituents.

12. The method according to claim 10, further comprising one or more of the following:
providing a reaction liquid by dissolving a reagent using the sample constituents following the elution of the sample constituents;
carrying out an amplification reaction;
aliquoting the reaction liquid;
carrying out a detection reaction; and
evaluating the reaction result.

13. A control unit configured to execute program instructions stored in a memory to carry out and/or actuate method according to claim 10 in corresponding units .

14. A computer program configured to carry out and/or actuate the method according to claim 10.

15. A non-transitory machine-readable storage medium on which the computer program according to claim 14 is stored.

16. The treatment apparatus according to claim 1, wherein the first and second channel-crossover elements are T-shaped.

17. The treatment apparatus according to claim 2, wherein the at least two pumping chambers includes three pumping chambers arranged or connected in series in the row.
